(19) United States
(12) Patent Application Publication
(10) Pub. No.: US 2017/0129135 A1
(43) Pub. Date: May 11, 2017

(54) INJECTION MOLDING OF AQUEOUS SUSPENSIONS OF HIGH-TEMPERATURE CERAMICS

(71) Applicant: Purdue Research Foundation, West Lafayette, IN (US)

(72) Inventors: Jeffrey Paul Youngwood, Crawfordsville, IN (US); Rodney Wayne Trice, West Lafayette, IN (US); Valerie Lynn Wiesner, Bay Village, OH (US); Lisa Mae Rueschhoff, Omaha, NE (US); Andres Ignacio Diaz Cano, West Lafayette, IN (US)

(21) Appl. No.: 15/192,376

(22) Filed: Jun. 24, 2016

Related U.S. Application Data
(60) Provisional application No. 62/184,292, filed on Jun. 25, 2015.

(51) Int. Cl. B28B 1/24; B29B 7/02; B29B 7/74; B29C 45/00; C04B 35/64; C04B 35/10; C04B 35/626; C04B 35/634; C04B 35/638; B28B 11/24; B29C 45/03

(52) U.S. Cl. CPC B28B 1/24; B28B 11/243; B29B 7/02; B29B 7/7461; B29C 45/0001; B29C 45/0053; B29C 45/03; C04B 35/10; C04B 35/6264; C04B 35/63444; C04B 35/638; C04B 35/64; C04B 35/6263; B29K 2477/00

(57) ABSTRACT

A method for ambient temperature injection molding of ceramic bodies, including combining ceramic powder, water, and dispersant to yield a first admixture, combining water and water soluble polymer to yield a second admixture, combining the first and second admixture to yield a homogeneous slurry, flowing the homogeneous slurry into a mold to yield a molded green body, and removing the green body from the mold, all of which are performed at room temperature. The slurry exhibits yield psuedoplastic flow characteristics and contains more than 50 weight percent ceramic powder and less than 5 weight percent water soluble polymer.

### CROSS-REFERENCE TO RELATED APPLICATIONS

This patent application claims priority to co-pending U.S. Provisional Patent Application Ser. No. 62/184,292, filed on Jun. 25, 2015, the contents of which are incorporated herein by reference.

This invention was made with government support under CMMI0726304 awarded by the National Science Foundation, P200A10036 awarded by the U.S. Department of Education, and W911NF-13-1-0425 awarded by the U.S. Army Research Office. The government has certain rights in the invention.

### TECHNICAL FIELD

The present disclosure generally relates to ceramic fabrication, and in particular to methods for injection molding aqueous suspensions of high-temperature ceramics.

### BACKGROUND

This section introduces aspects that may help facilitate a better understanding of the disclosure. Accordingly, these statements are to be read in this light and are to be understood to not be admissions about what is or is not part of the prior art.

Injection molding is a powerful high-throughput forming method that allows for rapid production of near-net shape ceramic components. Current ceramic injection molding technology relies heavily on injection molding machinery that heats precursor slurries or feedstock prior to forcing the same into a mold, and then cooling the mold to yield a solid or quasi-solid body. Additionally, such feedstocks often include multiple binders or fillers. The majority of the alternative aqueous, room-temperature casting technologies require that feedstocks contain reactive chemicals to facilitate in situ chemical reactions (i.e. polymerization, crosslinking, curing, or the like) and/or require carefully controlled temperatures throughout processing to form and/or solidify molded bodies.

The type and amount of organic components are selected to impart the desired properties to the ceramic suspension, and allow for tailoring the formation of a robust ceramic component by injection molding. Traditionally, most feedstocks used in injection molding are based on thermoplastic polymers, commonly polypropylene or low-density polyethylene, and then combined with some type or blend of wax and a dispersant, like stearic acid. The organic content of a feedstock is commonly 20 weight percent or higher, depending on the material system. Prior to sintering, the binder component must be removed, such as by pyrolysis, solvent debinding, or other mechanism, without negatively affecting the structural integrity of the part. The inclusion of a polymer binder often imparts strength to formed green bodies, although the amount of binder employed can lead to a great deal of porosity within a specimen upon binder removal, causing significant shrinkage or warping, loss of strength, impairment of physical and mechanical characteristics, and/or preventing full densification of the final part. Traditionally, the development of ceramic injection molding has relied heavily on the use of organic solvents. Because aqueous feedstocks pose significant advantages over the incorporation of more toxic materials and solvents into feedstocks due to their low impact on the environment and on human health, significant advancement has been made in the development of aqueous injection molding processes. Binders based on methylcellulose or polysaccharides like agar, which gel at temperatures at or below 37° C., have been incorporated into water-based feedstocks for injection molding. Feedstocks based on binders that require temperature-induced gelation must be heated to uniformly mix. Additionally, the injection molding operation itself requires heating of the feedstock to decrease viscosity to enter a mold cavity as well as cooling to solidify the part after forming. The binder must give ideal flow properties to a feedstock such that when heated or cooled allow for production of near-net shape parts without defects. Consequently, binder selection as well as the careful control of feedstock temperatures during mixing and injection molding is critical to develop a novel suspension suitable for ceramic injection molding.

There is therefore an unmet need for a technology that accomplishes injection molding in an environmentally friendly and cost effective manner. The present novel technology addresses this need.

### BRIEF DESCRIPTION OF THE DRAWINGS

FIG. 1 is a schematic drawing of one embodiment of a room-temperature injection molding device of the present novel technology.

FIG. 2A is a ring-shaped mold for use with the device of FIG. 1.

FIG. 2B is an enlarged partial perspective view of the injection molding device of FIG. 1.

FIG. 3 is a top plan view of a machined and sintered C-shaped alumina body produced from the device of FIG. 1.

FIG. 4 is a schematic view of the body of FIG. 3.

FIG. 5 is a graphical plot of flow curves for various alumina suspensions with varying PVP concentrations, plotting shear stress vs. shear rate.

FIG. 6 graphically illustrates viscosity as a function of shear rate for alumina suspensions with varied PVP concentrations.

FIG. 7A is a top plan view of a green injection molded alumina ring after finishing having a concentration of 1 volume percent PVP produced from the device of FIG. 1.

FIG. 7B is a top plan view of a green injection molded alumina ring after finishing having a concentration of 2.5 volume percent PVP produced from the device of FIG. 1.

FIG. 7C is a top plan view of a green injection molded alumina ring after finishing having a concentration of 5 volume percent PVP produced from the device of FIG. 1.

FIG. 8A is a photomicrograph of an alumina surface prepared from a suspension having 1 volume percent PVP and produced from the injection molding device of FIG. 1.

FIG. 8B is a photomicrograph of an alumina surface prepared from a suspension having 2.5 volume percent PVP and produced from the injection molding device of FIG. 1.

FIG. 8C is a photomicrograph of an alumina surface prepared from a suspension having 4 volume percent PVP and produced from the injection molding device of FIG. 1.

FIG. 8D is a photomicrograph of an alumina surface prepared from a suspension having 5 volume percent PVP and produced from the injection molding device of FIG. 1.

FIG. 9 graphically illustrates average strength as a function of PVP content for several C-rings produced from the injection molding device of FIG. 1.

FIG. 10 graphically illustrates viscosity as a function of shear rate for alumina suspensions having 2.5 volume percent PVP and having varying molecular weights.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

As discussed above, injection molding is a powerful high-throughput forming method that allows for rapid production of near-net shape ceramic components, and has tended to rely heavily molding techniques and systems that heat slurries for forcing into a mold, which is then cooled to yield a green body. Traditionally, these feedstocks typically include a plethora of chemical binders and/or fillers. The instant novel technology obviates the need for heated feedstock slurries or suspensions by taking advantage of the room-temperature flow properties of ceramic suspensions having additions of water soluble polymers such as polyvinylpyrrolidone (PVP). These suspensions typically contain only ceramic powders, water soluble polymers (such as PVP), dispersants, and water. The novel precursor slurries are typically environmentally friendly and are more typically inexpensive to prepare and/or process.

One attractive feature of the novel slurries is that the dispersant package (dispersant and polymer) may be ‘tuned’ to obtain a desired rheology, such that the resulting slurry material is flowable enough to inject into a mold, yet with a high enough yield and viscosity to hold shape, either instantaneously or after a brief drying period, all while enjoying a relatively high ceramic content (typically at least 40 volume percent ceramic material, more typically upwards of 50 volume percent, and still more typically in excess of 50 volume percent ceramic material).

The novel technology reduces or eliminates the need for heating and cooling feedstock, such as is required in conventional injection molding. Additionally, the novel technology does not require complex in situ chemical reactions or temperature control as do other known molding and casting methods. The novel technology is a water-based processing method that effectively yields near-net shape high-temperature ceramic parts without the requirement of harsh crosslinking or curing agents and/or further chemical or heating processes. The resulting molded green bodies are machinable prior to binder removal, curing, calcining, and/or sintering, allowing for the quick machining of high-temperature ceramic bodies, which have been traditionally either too fragile prior to sintering and/or are too hard post calcination and/or sintering to machine, when prepared by traditional ceramic processes.

The rheology of a feedstock for injection molding is typically pseudoplastic, also referred to as shear thinning, or of a Bingham-type behavior, such that the feedstock does not flow at low shear stresses. The instant novel technology takes advantage of the unique yield-pseudoplastic flow properties (i.e. being both shear thinning and having a yield stress) of aqueous, highly loaded (typically greater than fifty volume percent) ceramic suspensions having a minimal amount (typically less than five volume percent) non-toxic, water-soluble polyvinylpyrrolidone (PVP) to support an aqueous, room-temperature processing method characterized by lower environmental burden and yielding dense, near-net shape ceramic (such as alumina) components. Through control of the yield point and inherent shear-thinning rheological response of yield-pseudoplastic ceramic suspensions by varying PVP content, the novel technology eliminates the need for heating and cooling feedstocks as required in conventional injection molding. Furthermore, high solid loadings often result in higher green and sintered densities, and lower organic content results in post-binder burnout green bodies with less porosity. Additionally, the novel method does not require complex in situ chemical reactions and/or temperature control as do conventional molding and casting methods.

The novel processing method effectively produces near-net shape alumina parts without the need for harsh crosslinking or curing agents or further chemical processes. By utilizing the yield pseudoplastic behavior of aqueous ceramic powder-PVP suspensions dispersed with a minimal amount of additive dispersant (such as DARVAN 821A, DOLAPIX CE 64, or the like) dense ceramic bodies may be prepared by injection molding at room temperature (DARVAN is a registered trademark of Vanderbilt Minerals, LLC, 30 Winfield Street, Norwalk, Conn., 06856). PVP content in suspensions may be varied to optimize formulations to exhibit desired flow properties amenable to the fabrication of ceramic bodies having desired compositions and to yield specific microstructural and mechanical properties by room-temperature injection molding.

In general, a slurry is prepared by combining predetermined amounts of one or more ceramic powder precursors, one or more dispersants, one or more water soluble polymers, and water. The slurry is typically homogeneously mixed. In some cases, the one or more ceramic powder precursors and one or more dispersants are first mixed with a quantity of water and another quantity of water is mixed with the predetermined amount of water soluble polymer, which are then mixed together to yield the slurry. The slurry is typically characterized as having yield-pseudoplastic flow properties, insofar as it behaves as a solid until sufficient shear force is applied to initiate flow. The slurry is prepared and maintained at ambient temperature.

The slurry is then injected into a mold, still at ambient temperature. The mold typically includes one or more overflow ports operationally connected thereto for directing excess slurry material from the mold, so as to ensure even flow and distribution of the slurry throughout the mold. The mold may also be vibrated to urge air bubbles therefrom during the injection process.

Once the injection process is complete, the slurry filling the mold may be considered a pseudobody, insofar as without application of a sufficiently great shear force, the yield pseudoplastic character of the slurry causes the slurry to behave as a solid. The pseudobody in the mold may then be at least partially dried to yield a green body that may be removed from the mold. Alternately, the pseudobody may be removed as-is, so long as insufficient force is applied thereto to induce flow.

The green body or removed pseudobody may then be further dried, such as spending time residing in a drying oven to yield a dried green body. The green body, psuedobody and/or dried green body may be machined, if necessary, to yield a finished piece. Whether dried or not, the green body, pseudobody and/or finished piece may then be calcined to remove the water soluble polymer material (binder burnout), after which the calcined body may then be sintered to the extent necessary to yield a densified solid ceramic body.

### Example 1

Alumina suspensions were prepared using deionized (DI) water and alumina powder with BET surface area of 7.8±0.22 m2/g, and having an average particle size of 0.48±0.13 mm. DARVAN 821A was used as a dispersant. DARVAN 821A is a low-toxic aqueous solution of 40% ammonium polyacrylate with a molecular weight of 3500 g/mol that is highly soluble in aqueous systems. The polymer binder used was polyvinylpyrrolidone (PVP, 1-ethenyl-2-pyrrolidinone homopolymer) to modify the rheological properties of the suspension. An aqueous slurry was prepared using DI water, dispersant and alumina powder by ball milling with alumina milling media for 24 hours. Alumina powder was incrementally added to a dispersant and DI water solution to obtain highly loaded, dispersed alumina slurries. A typical slurry contained 225 g of alumina powder in 37 mL of DI water and 5 mL dispersant. A polymer solution of PVP and DI water was mixed separately by magnetic stirring for 4-8 h. After both the slurry and polymer solution were dispersed, the PVP-water mixture was added to the alumina slurry and ball milled over a 12-hour period. The amounts of PVP with molecular weight of 55,000 g/mol in suspensions so prepared were 1, 2.5, 4 and 5 vol. % to vary the binder content that to yield compositions having varied final sintered and mechanical properties. These compositions are highlighted in Table 1. Suspensions with 2.5 vol. % PVP with molecular weights of 10,000 g/mol, 360,000 g/mol and 1,300,000 g/mol (compositions listed in Table 2) were also prepared to evaluate the effect of molecular weight on the final properties of the sample bodies.

TABLE 1
Compositions of alumina-PVP suspensions with corresponding curve-fit parameters
using the Herschel-Bulkley equation for yield-pseudoplastic fluids, average
green and sintered densities and C-ring strength values for sintered samples prepared
by room-temperature injection molding of suspensions with varying content
of PVP with molecular weight of 55,000 g/mol.

| | | | | | | Average | | | Average |
|---|---|---|---|---|---|---|---|---|---|
| Al₂O₃ powder | Polymer | Dispersant | | | | green | Average sintered | Average | C-ring |
| content in | content in | content in | | k | | density in | bulk density in | grain size | strength |
| vol. % (wt. %) | vol. % (wt. %) | vol. % (wt. %) | σ_{y}(Pa) | (Pa sₙ) | n | g/cm3(% TD) | g/cm3(% TD) | (fm) | (MPa) |
| 57.9 (84) | 0 (0.0) | 4.4 (1.9) | 4.57 | 3.94 | 0.408 | 2.56 ± 0.2 (64) | 39.2 ± 0.02 (98) | — | — |
| 56.7 (84) | 1 (0.5) | 4.3 (1.9) | 25.1 | 7.47 | 0.391 | 2.52 ± 0.01 (63) | 3.88 ± 0.02 (98) | 3.20 ± 2.5 | 206 ± 36.5 |
| 54.9 (82) | 2.5 (1.2) | 4.2 (1.8) | 30.7 | 26.1 | 0.279 | 2.50 ± 0.02 (63) | 3.89 ± 0.01 (98) | 3.66 ± 2.5 | 261 ± 57.6 |
| 53.0 (81) | 4 (1.9) | 4.0 (1.8) | 35.3 | 17.1 | 0.326 | 2.43 ± 0.02 (61) | 3.88 ± 0.02 (98) | 3.18 ± 2.0 | 210 ± 31.8 |
| 51.7 (80) | 5 (2.5) | 3.9 (1.8) | 59.4 | 12.8 | 0.398 | 2.38 ± 0.06 (60) | 3.84 ± 0.06 (97) | 3.40 ± 2.2 | 192 ± 27.2 |

TABLE 2
Alumina suspension compositions with corresponding Herschel-Bulkley curve-fit parameters, average green
and sintered densities and C-ring strength values for sintered samples prepared by room-temperature injection
molding of suspensions with 2.5 vol. % PVP of varying molecular weights.

| | A1₂O₃ | | | | | | | | |
|---|---|---|---|---|---|---|---|---|---|
| PVP | powder | Polymer | Dispersant | | | | | Average | Average |
| molecular | content in | content in | content in | | | | Average green | sintered bulk | C-ring |
| weight in | vol. % | vol. % | vol. % | | | | density in | density in | strength |
| g/mol | (wt. %) | (wt. %) | (wt. %) | σ_{y}(Pa) | k (Pa sₙ) | n | g/cm3 (% TD) | g/cm3 (% TD) | (MPa) |
| 10,000 | 55.1 (83) | 2.5 (1.2) | 4.2 (1.8) | 12.6 | 12.0 | 0.320 | 2.48 ± 0.04 (62) | 3.88 ± 0.03 (98) | 233 ± 73.8 |
| 55,000 | 54.9 (82) | 2.5 (1.2) | 4.2 (1.8) | 30.7 | 26.1 | 0.279 | 2.50 ± 0.02 (63) | 3.89 ± 0.01 (98) | 261 ± 57.6 |
| 360,000 | 53.9 (82) | 2.5 (1.2) | 4.1 (1.8) | 52.7 | 8.48 | 0.510 | 2.41 ± 0.02 (60) | 3.86 ± 0.04 (97) | 246 ± 59.8 |
| 1,300,000 | 52.4 (81) | 2.5 (1.2) | 4.0 (1.8) | 56.8 | 4.92 | 0.621 | 2.36 ± 0.03 (59) | 3.78 ± 0.05 (95) | — |

### Room Temperature Injection Molding Procedure, Binder Burnout and Pressureless Sintering

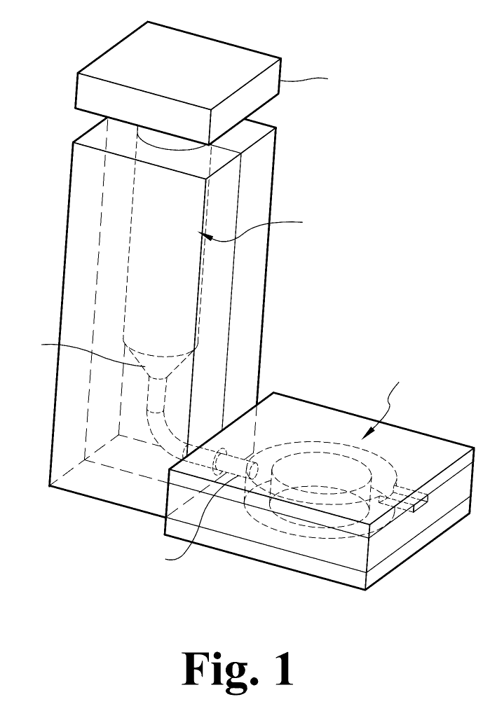

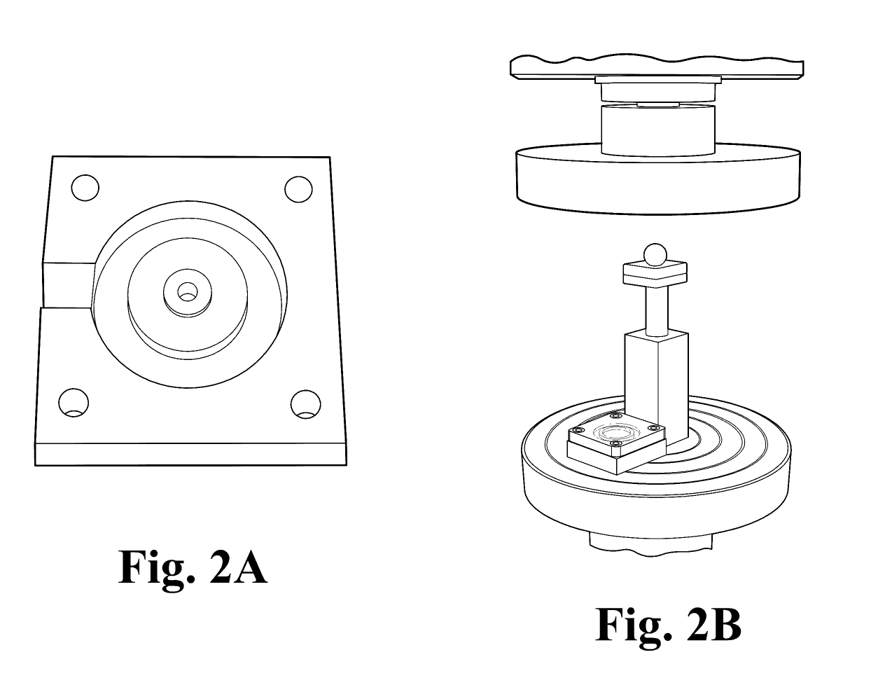

Because commercially available ceramic injection molding machines traditionally use heating and cooling processes throughout the forming procedure, a novel room-temperature injection molding apparatus was constructed. The mold cavity was specifically designed to produce a part that would be amenable to characterization, matching ASTM C1323-10 for the determination of the ultimate strength of compressively loaded ceramic C-ring specimens. By fabricating a ceramic ring rather than a body enjoying simpler, more common geometry (such as a bar), the process was predictive for overcoming complications inherent to the production of ring-shaped parts, such as convergent flow effects during filling that may result in potential pore or defect formation in addition to the development of hoop stresses during solidification and drying that give rise to cracks. A mold was made to fabricate a ceramic ring-shaped green body with a 2.54-cm outer diameter, 1.5875-cm inner diameter and a width of 6.35 mm (refer to FIG. 1), and three ports out of which excess material could flow during filling (shown in FIG. 2A). The bottom plate and outer ring support with injection port were machined from steel. A cylindrical rod with a diameter and height of a 6.35 mm was inserted in the center of the bottom plate, and a 6.35-mm section of EPDM (ethylene propylene diene monomer) closed-cell foam rubber tube with a firmness of ˜5-9 psi and outer diameter of 1.5875 cm and inner diameter of 6.35 mm was placed on the rod. The top plate was machined from transparent PLEXIGLAS (PLEXIGLAS is a registered trademark of the Arkema Corporation, 420 rue d'Estienne d'Orves, Colombes, France 92700). A low-friction TEFLON tape and Grade 40 ashless filter paper were adhered to the top and bottom steel plates of the ring-shaped die that came in contact with the ceramic-PVP suspension during filling to facilitate more rapid demolding and cleaning of molds (TEFLON is a registered trademark of the Chemours Company, 1209 Orange Street, Wilmington, Del., 19801). Top and bottom plates were then fitted above and below the outer ring support, respectively, using screws to secure the plates together to define a mold cavity. The mold cavity was then attached to the suspension chamber with a 3.175-mm-diameter rubber O-ring fixed between the two to ensure a tight seal, resulting in a 3.175-mm-diameter sprue, through which the suspension entered the mold cavity from the suspension chamber. TEFLON spray was used to lubricate the inner surfaces of the mold cavity and chamber prior to suspension loading to facilitate the removal of a formed part from the mold. The injection mold chamber was loaded with 5 mL of the alumina-PVP suspension using a 6-mL luer-slip syringe. The cylindrical 1.27-cm diameter steel pushrod was inserted into the cylindrical chamber with diameter of 1.27 cm, and the entire mold apparatus was placed between compression platens in an electromechanical test frame, as shown in FIG. 2B.

A compression force at a crosshead speed of 100 mm/min was transferred to a 1.27-cm diameter ball bearing sitting atop the pushrod to ensure that the load was uniformly applied to the pushrod. This force, applied at a constant rate on the pushrod, exerted sufficient pressure to overcome the yield point of a yield-pseudoplastic suspension, causing the suspension to flow and fill the ring-shaped mold cavity, yielding an alumina ring. A miniature air piston vibrator was attached to the mold using cable ties. The pneumatic vibrator had a frequency of 16,000 vibrations per minute at 80 psi and was initiated immediately prior to filling for the duration of the injection molding process to assist in the filling of the mold by preventing closed pore formation due to air bubbles. The injection mold setup is highlighted in FIG. 2B. After formation, the as-formed body was allowed to dry at ambient conditions for 1 hour prior to removal from the mold.

The binder burnout cycle for formed alumina-PVP samples was determined by thermogravimetric differential thermal analysis of PVP, which indicated significant weight loss beginning at 325° C. and ending at 480° C. Removal of the binder from the formed samples was accomplished in a tube furnace heated at a rate of 2° C./min to a soak temperature of 700° C. with an isothermal hold of 1 hour followed by cooling to room temperature. The calcined body was then transferred to a 1700° C. box furnace for pressureless sintering, heating at a rate of 5° C./min to 1620° C. with a 1.5-hour soak to densify the alumina ring.

A rheometer with a 40-mm parallel-plate geometry and a gap of 500 mm was used to characterize the rheological responses of suspensions with varying PVP contents at 25° C. A moisture trap was also employed during testing to avoid temperature differences and premature drying of the suspension while testing. By considering the sprue diameter of 3.175 mm and the applied compression rate of 100 mm/min used for room-temperature injection molding, the shear rate applied to alumina-PVP suspensions during forming was determined to be 4.20 s⁻¹. The calculated shear rate is significantly lower than that of traditional injection molding, which can be on the order of 100-1000 s⁻¹. Consequently, flow curves up to a maximum shear rate of 100 s⁻¹ were obtained to quantify the low-shear rheological behavior of the alumina-PVP suspensions utilized in this study. Flow curves were fitted to the Herschel-Bulkley model for yield-pseudoplastic fluids, which was defined as:

σ=σ_{y}+kγ′ⁿ Eq(i)

where a was stress, σ_{y} represented the shear yield stress, γ′ was the shear rate applied to the material, the consistency or apparent viscosity was k and flow index of the material was n, which varied from 0 to 1. Flow behavior was considered yield pseudoplastic when a suspension demonstrated a yield stress and n<1. The yield stress of each suspension evaluated was found by extrapolating its curve fit to the axis limits, and the correlation factor, R, of fitting the curve parameters to Eq. (1) was always ˜0.99.

After a ring-shaped alumina part was formed via injection molding, it was then machined before binder removal to chamfer the outer edges and ensure sample surfaces were sufficiently parallel in accordance with the ASTM C1323-10 C-ring test using a polishing wheel with 320, 400 and 600 grit silicon carbide grinding cloth. To qualitatively assess the green machinability of parts formed prior to binder burnout, a custom steel polishing mount with micrometer was machined to the exact dimensions of the alumina ring-shaped part such that every specimen polished experienced identical machining conditions. Each sample was inserted into the mount and polished using silicon carbide polishing papers of 320, 400 and 600 grit for 30 s on each paper in increasing order at ˜200 rotations per minute (RPM). The effect of machining in the state prior to binder removal was qualitatively observed by examining the final surface finish of each sample for fracture, cracking or chipping after polishing.

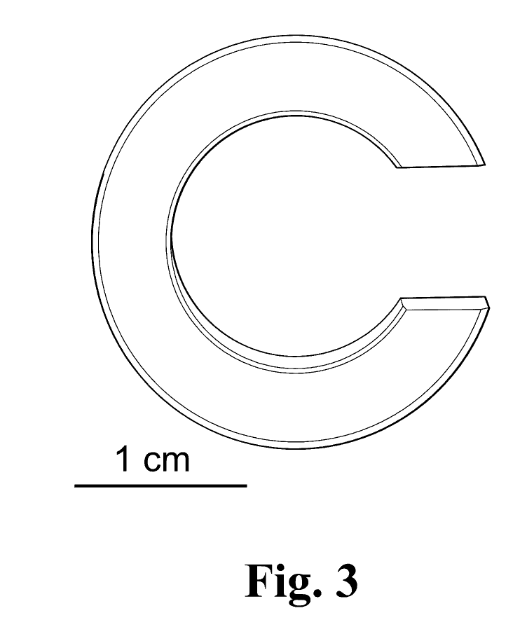

Density of the alumina parts before and after sintering was measured using the Archimedes technique. Microstructural analysis was performed using a scanning electron microscope (SEM) to examine sintered, polished and thermally etched (1400° C., 1-h hold) samples. The average grain size was determined by evaluating five SEM micrographs for a particular sample composition and measuring the length of 50 arbitrary grains in each image using ImageJ image processing and analysis software. A total of 250 line segments representing 250 different grain lengths were averaged to obtain a mean grain size for each composition. A slow-speed saw with a diamond blade was used to cut a notch in the densified specimens resulting in the desired C-shape for mechanical testing (refer to FIG. 3). If the heat treatments resulted in warping of the ring-shaped sample, it was placed on a mandrel with adjustable diameter and then machined using a diamond-tipped blade on a rotating lathe to ensure outer surfaces were parallel for mechanical testing.

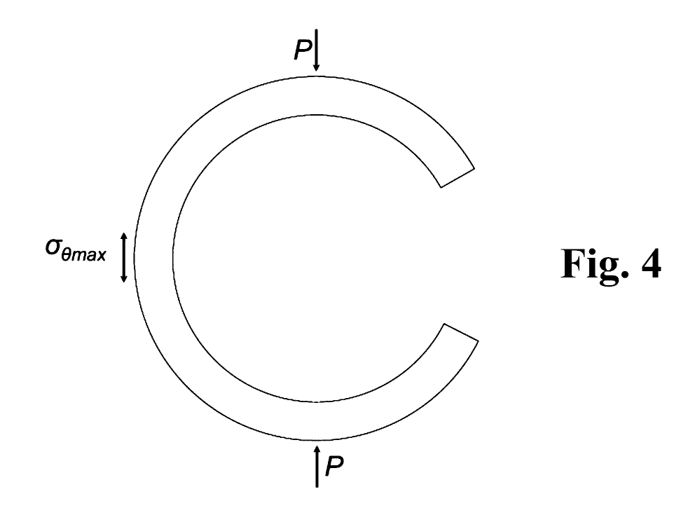

Each C-ring specimen was positioned between two MTS platens of an electromechanical test frame as highlighted in FIG. 4 and compressively loaded until fracture in accordance with ASTM C1323-10 to determine ultimate strength of the specimens. The maximum engineering tangential (hoop) stress, σ_{θmax}, which occurred on the outer edge of the specimen as indicated in FIG. 4, was calculated by utilizing the maximum compressive load, P, applied by platens of the electromechanical test frame initiating fracture. At least six samples were tested to obtain an average C-ring strength for a given suspension composition. The ASTM C1323-10 mechanical characterization method is particularly sensitive to external surface flaws as it causes maximum tension at the outer surface of the specimen. After mechanical testing fractographic analysis was performed following the procedure outlined in ASTM C1322-05b to evaluate the angle and origin of fracture for each specimen using a zoom stereo microscope.

A two-tailed t-test was applied to compare the means of the densities, grain sizes and mechanical strengths for varying PVP content to determine if data sets were statistically different. To infer whether a Student's t-test for samples with equal variance (homoscedastic) or a Cochran's t-test for samples with unequal variance (heteroscedastic) should be applied, an F-test was used to calculate the ratio, F0, of the two variances. Two data sets were considered homoscedastic when the value of F0 fell between the upper- and lower-tail percentage points, F0.05, u, v and F0.95, u, v, respectively, with u and v being the degrees of freedom, and heteroscedastic when F0>F_{0.05, u, v} or F0<F_{0.95, u, v}. The p values calculated from either the Student's or Cochran's t-tests using the Excel function, TTEST, were considered to be statistically different when p<0.05.

Rheological Behavior and Processability of Alumina Suspensions with Varying PVP Content

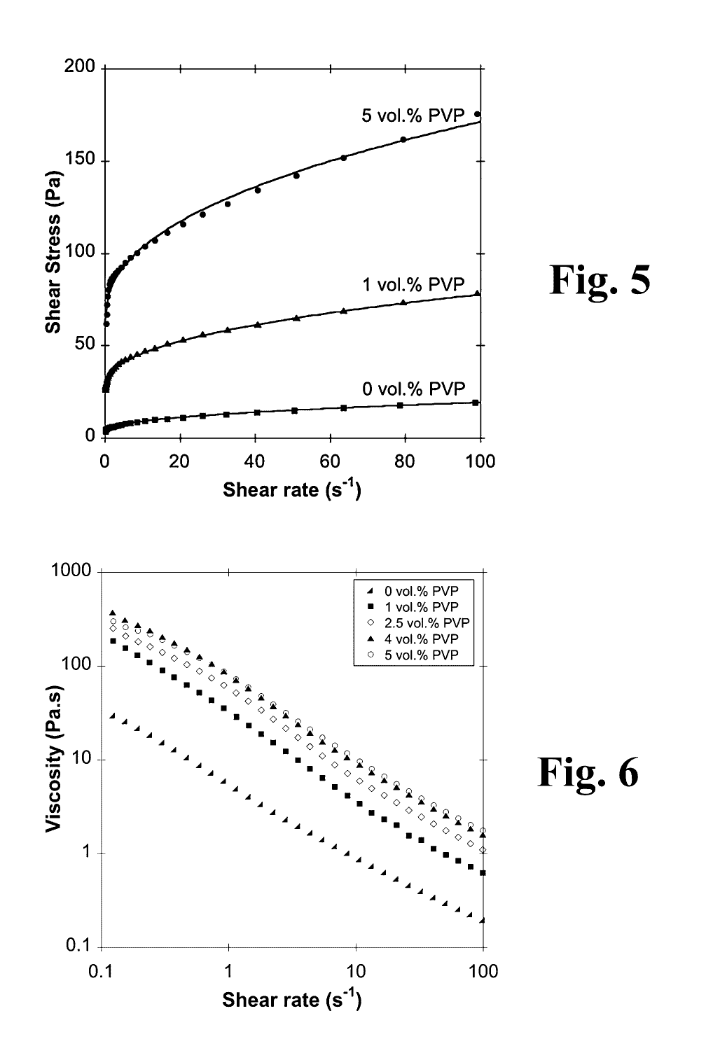

Flow curves of alumina-PVP suspensions prepared with ˜4 vol. % Darvan 821A for polymer contents of 0, 1, 2.5, 4 and 5 vol. % PVP (MW=55,000 g/mol) with powder loadings of 57.9, 56.7, 54.9, 53.0 and 51.7 vol. % alumina, respectively, suggested that suspensions behave as yield-pseudoplastic fluids regardless of PVP or powder content with curve fit parameters to the Herschel-Bulkley model listed in Table 1. An increase in yield strength, which often indicates flocculation within a suspension, would be expected with an increase in overall solids content. Because both PVP and powder contents were varied simultaneously in this study, the marked difference in flow properties could not be simply attributed to the amount of PVP or powder incorporated into a suspension. The 0 vol. % PVP suspension, which had the highest solids loading, had a yield point of 4.57 Pa, and laboratory observations indicated it flowed due to gravitational forces. FIG. 5 shows the flow curves for 0, 1 and 5 vol. % PVP compositions with corresponding curve fits to the Herschel-Bulkley model (correlation factor, R>0.99). With increasing PVP and decreasing powder contents, an increase in yield shear stress, σ_{y}, was observed. The suspension without polymer had the lowest yield point observed in this study, suggesting that PVP, even in small amounts, greatly affected the rheology of the suspensions examined for room-temperature injection molding.

During forming the yield point of suspensions without PVP was observed to be too low, as suspensions flowed into the mold before pressure was applied to the suspension via the load frame. This suggested that the rate at which the suspensions entered the mold could not be adequately controlled, resulting in unpredictable flow patterns that could cause defects in formed specimens, thus, making suspensions without PVP undesirable for room-temperature injection molding. With the introduction of a small amount of polymer, all suspensions containing PVP exhibited a yield shear stress high enough that suspensions did not flow prematurely into the mold cavity until after pressure was initiated using the load frame. Additionally, after the suspension completely filled the mold and pressure was removed, the suspension did not flow allowing the suspension to retain its shape during drying, confirming that PVP was necessary to control the flow properties of alumina suspensions for room-temperature injection molding.

Although yield point increased with PVP content, the change in consistency, k, and flow index, n, exhibited a more complex relationship with PVP content. Consistency increased until a peak value of 26.1 Pa sⁿ was attained at a PVP concentration of 2.5 vol. % and then began to decrease with increasing PVP content. All flow indices indicated that suspensions were highly shear thinning regardless of PVP content. A maximum flow index of 0.408 was observed for suspensions containing no polymer, and n decreased until a minimum value of 0.279 was observed for 2.5 vol. %, suggesting that this composition was the most shear thinning. The flow index then began to increase once again at PVP contents >2.5 vol. %. A highly shear-thinning response was most desirable as a relatively low viscosity aided in the complete filling of the mold and minimized pore formation by allowing entrained air bubbles to be ejected from the suspension more readily during injection molding with the pneumatic vibrator, thus enhancing processability. FIG. 6 shows a comparison of the apparent viscosity at different shear rates of all suspensions examined in this study. It was observed that viscosity also increased with increasing polymer content, while decreasing at higher shear rates for all formulations examined due to the pseudoplastic nature of the suspensions evaluated.

The pH of suspensions with varying PVP content changed negligibly and was 9.6±0.05, which was above the isoelectric point (IEP) of alumina in water. It has been observed that the surface charge of PVP is effectively neutral such that it does not alter the IEP of alumina-water suspensions. The rheological results matched the findings of a previous study, which examined alumina-PVP suspensions with a Dolapix CE64 dispersant. This past study surmised that neutral PVP introduced a small amount of flocculation, because yield stress was indicative of flocculation within a suspension. By increasing polymer content or molecular weight, this weak flocculation could be enhanced, manifesting itself as an increase in yield stress. This manipulability allows for the careful control and engineering of the flow properties of suspensions with minimal amounts of polymer to tailor suspensions to a variety forming applications. To determine the ideal properties of suspensions for room-temperature injection molding, a variety of characterization methods were utilized to find the optimal compositions that yielded dense, strong alumina parts.

### Green Machinability and Density of Alumina Components

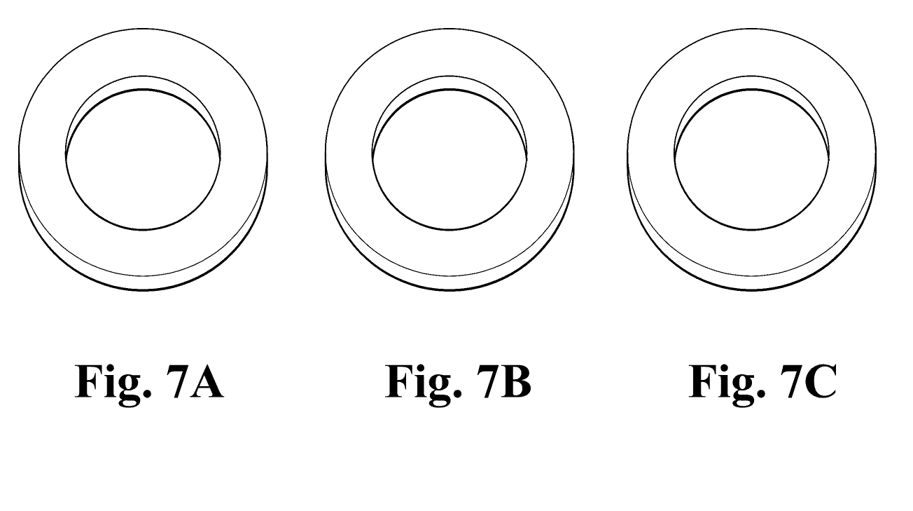

Ring-shaped specimens were successfully prepared by room temperature injection molding, suggesting that hoop stresses that developed during drying were minimized, making this a near-net shape drying process. Although sections of the specimen remained in contact with the mold during drying, no cracking due to drying gradients was observed, suggesting that capillary forces during drying did not cause defects. Prior to binder removal alumina green bodies produced by room-temperature injection molding of ceramic-PVP suspensions with varying polymer amount were deemed machinable such that the samples did not crack or shatter during the polishing procedure. It was observed that increasing binder content enhanced the machinability of the green bodies. As highlighted in FIG. 7, green bodies formed using suspensions with ≧2.5 vol. % PVP exhibited little chipping or cracking compared to samples made with suspensions consisting of 1 vol. % PVP. Samples prepared with 0 vol. % PVP often did not have enough structural integrity to be removed from the mold after forming and broke either during mold removal or polishing. It was concluded that samples without PVP were too fragile to be machined in the green state using the polishing wheel and mount. Suspensions with PVP contents of 2.5, 4 and 5 vol. % were less brittle and thus less likely to chip or crack during machining using the polishing mount, suggesting that parts made using these compositions could be polished in an automated process. Note that while the 1 vol. % PVP suspensions could not be polished using the polishing mount without introducing defects, it could be polished by hand. This method was used to prepare 1 vol. % PVP suspensions for mechanical testing.

Table 1 highlights the green density values of specimens prepared with suspensions containing varying PVP contents after binder removal. Alumina samples made by room-temperature injection molding exhibited green densities >60% of the true density (TD=3.98 g/cm3) of alumina regardless of initial PVP content. Specimens prepared with 0 vol. % PVP exhibited the highest green density of 2.56 g/cm3 (64% TD). Of the specimens prepared with polymer-containing suspensions, those consisting of 1 and 2.5 vol. % PVP were statistically the same (p=0.26) with 2.52±0.01 g/cm3 (63% TD) and 2.50±0.02 g/cm3 (63% TD), respectively, and exhibited statistically higher green densities than 4 and 5 vol. % PVP. The green density p-values for specimens prepared with 1 vol. % PVP when compared with 4 and 5 vol. % PVP suspensions were p1 vol. %, 4 vol. %=7.3×10-3 and p1 vol. %, 5 vol. %=0.0041, respectively, and for specimens initially containing 2.5 vol. % PVP compared with 4 and 5 vol. % PVP suspensions were p2.5 vol. %, 4 vol. %=0.00042 and p2.5 vol. %, 5 vol. %=0.005, respectively. These p-values were less than 0.05 suggesting that the green density data sets were statistically different, whereas specimens prepared with 4 and 5 vol. % PVP suspensions were statistically similar (p4 vol. %, 5 vol. %=0.10). Overall, parts formed by room-temperature injection molding using suspensions with PVP were successfully machined and sintered into the desired C-shaped part in accordance with the ASTM standard as highlighted in FIG. 3.

### Sintered Density and Microstructure

Archimedes density analysis confirmed that samples reached ˜98% TD regardless of initial PVP content after binder burnout and pressureless sintering. Specimens prepared without PVP exhibited statistically higher sintered density values. Although the density of samples prepared with suspensions using 5 vol. % PVP appeared to decrease, the density values were determined to be statistically similar to samples using other compositions with lower PVP contents. This suggested that polymer content did not dramatically influence the final density and internal porosity of the ceramic part. Density results are highlighted in Table 1. Linear shrinkage for all samples after sintering was <16%.

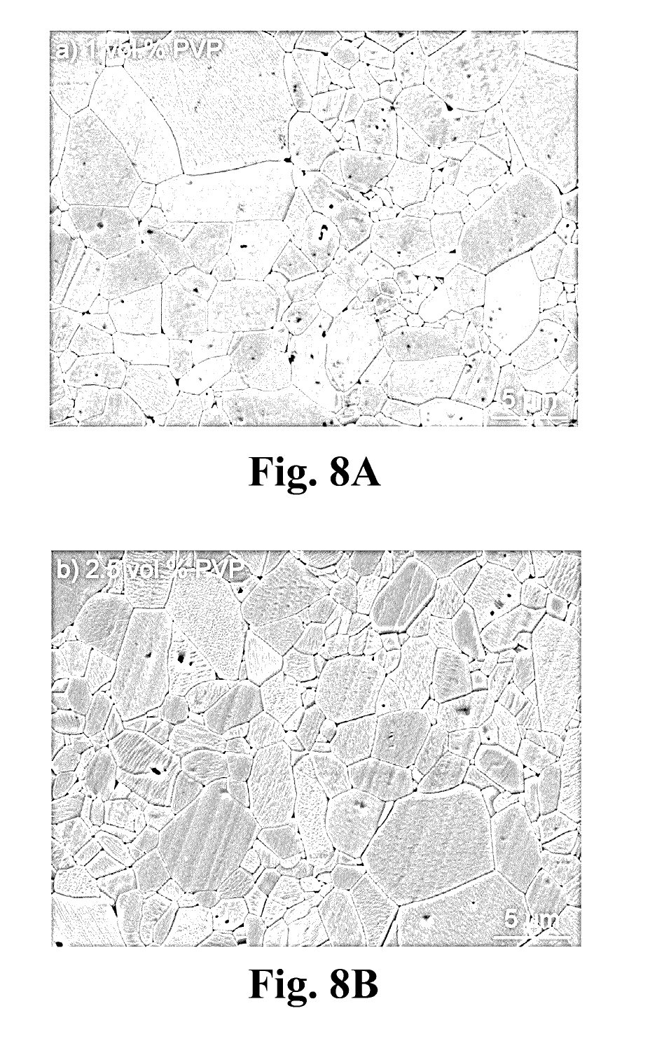

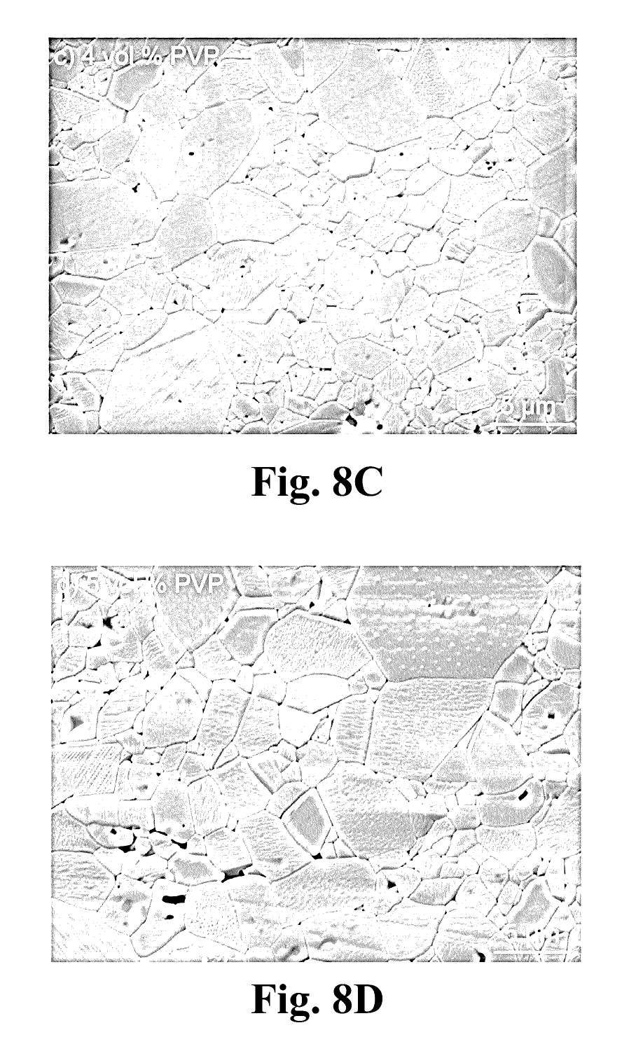

Analysis of the internal structure using SEM revealed an overall dense microstructure with some porosity between and within grains (micrographs of samples prepared with 1, 2.5, 4 and 5 vol. % PVP are shown in FIG. 8). By applying a t-test, the mean grain size of specimens prepared with 2.5 vol. % PVP was determined to be statistically larger than those containing 1 and 4 vol. % PVP as p<0.05 (p_{1 vol. %, 2.5 vol. %}=0.043 and p_{2.5 vol. %, 4 vol. %}=0.019) yet similar to specimens using 5 vol. % PVP (p_{1 vol. %, 5 vol. %}=0.22), which was similar to all compositions evaluated. Mean grain sizes of specimens manufactured using suspensions with different PVP contents are highlighted in Table 1. The slight discrepancies in values suggested that there was no apparent trend with PVP content that resulted in a particular grain size, although 2.5 vol. % yielded slightly higher grain sizes than 1 and 4 vol. % PVP suspensions.

### Mechanical Properties

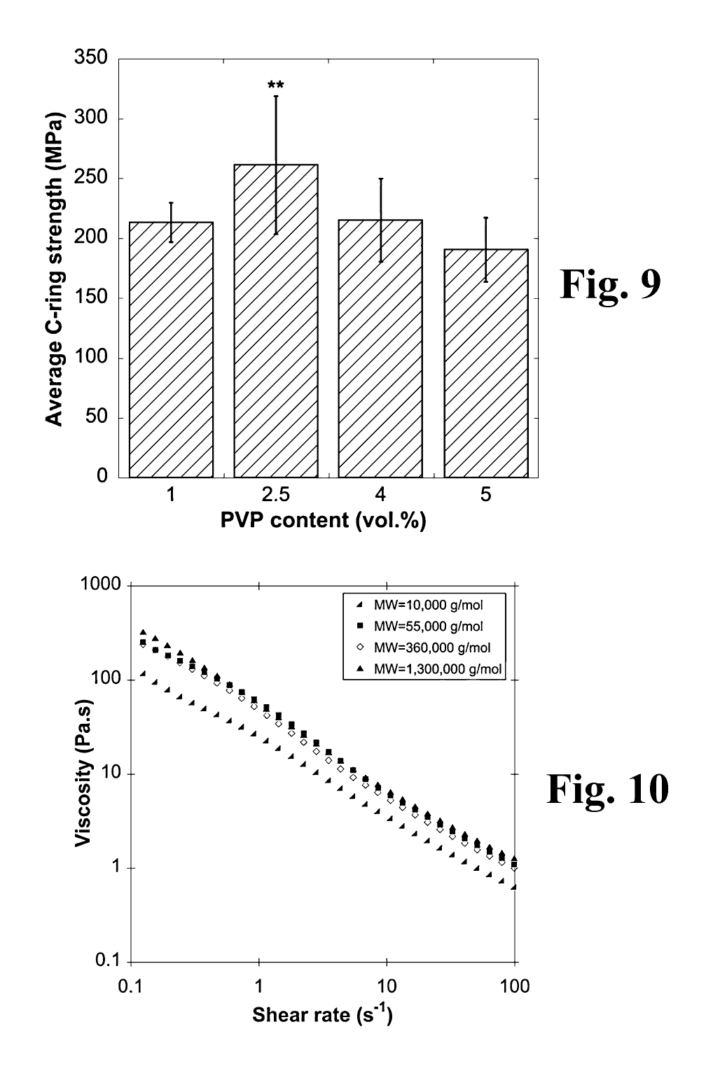

Average C-ring strength values that were determined using the ASTM C1323-10 test for samples fabricated using alumina suspensions with 1, 2.5, 4 and 5 vol. % PVP are shown in Table 1 and plotted in FIG. 9. Despite the fact that specimens of 2.5 vol. % PVP had a mean grain size that was statistically similar to those with 5 vol. % PVP and higher than specimens of 1 and 4 vol. %, there was a statistically significant peak of 261±57.6 MPa in strength for 2.5 vol. % PVP content (p_{1 vol. %, 2.5 vol. %}=0.04, p_{2.5 vol. %, 4 vol. %}=0.036 and p_{2.5 vol. %, 5 vol. %}=0.024). Samples with 5 vol. % PVP exhibited a significant drop in average C-ring strength, though the values were found to be statistically similar to the strengths of samples prepared with 1 and 4 vol. % PVP suspensions. When comparing the values from this study to those in literature, an average C-strength value was found to be 230 MPa for commercially available surface-finished 99.8% pure alumina tubular specimens and 275.3±16.6 MPa for tubular gun barrel specimens prepared using 95% pure alumina. The method of preparation for these tubular specimens is unknown due to proprietary information, but the density and C-strength values obtained by room-temperature injection molding of alumina-polymer suspensions is comparable.

The ASTM C1323-10 test is prone to causing fracture at defects located at the outer surface of specimens. The increase in strength for specimens prepared using 2.5 vol. % PVP suggested that the distribution and size of pores within these samples, not the size of grains, minimized their influence on failure resulting in higher C-strength values. Fractographic analysis revealed that the majority of fractures originated at pores on or near the outer surface of C-rings regardless of PVP content, intimating that the amount of PVP in a suspension affected the overall arrangement and/or size of strength-limiting pores that resulted in fracture at lower loads for samples prepared with 1, 4 and 5 vol. % PVP suspensions. The favorable mechanical and microstructural properties of specimens prepared with 2.5 vol. % PVP implied that the flow behavior of such suspensions, including the relatively low viscosity and flow index, which allowed the suspension to fill the mold and minimize strength-limiting defect development, was ideal for processing by room-temperature injection molding. In spite of this conclusion, the large standard deviation in all samples, particularly samples prepared with 2.5 vol. % PVP, suggest that further processing improvements are needed to tighten this distribution and improve the reproducibility of dense, high-strength alumina parts with uniform microstructures.

### Varying Molecular Weight at Optimal PVP Concentration

The desirable flow properties and apparent peak in strength along with relatively high green and sintered densities suggested that 2.5 vol. % PVP was the optimal concentration of polymer to use in the alumina suspensions for room-temperature injection molding. Three additional suspensions using PVP with molecular weights of 10,000, 360,000 and 1,300,000 g/mol with alumina contents of 55.1 vol. %, 53.9 vol. % and 52.4 vol. %, respectively, were evaluated to determine the effect of molecular weight on the rheological behavior of the suspensions as well as on microstructural and mechanical properties of samples fabricated by room-temperature injection molding.

The formulations of the alumina-PVP suspensions prepared using 2.5 vol. % PVP with molecular weights of 10,000, 55,000, 360,000 and 1,300,000 g/mol are given in Table 2. Each composition exhibited yield-pseudoplastic behavior (refer to Table 2 for the Herschel-Bulkley model curve fit parameters) similar to that of suspensions prepared with varying contents of 55,000 g/mol PVP. It was observed that the yield points in suspensions increased with increasing molecular weight and decreasing powder content, while consistency values and flow indices varied with increasing molecular weight. Suspensions with 10,000 g/mol PVP exhibited the lowest yield stress of suspensions containing polymer, whereas the yield stress of formulations having PVP molecular weights ≧360,000 g/mol jumped significantly to >50 Pa, only surpassed in magnitude by suspensions with 5 vol. % PVP of 55,000 g/mol, which had _y=59.4 Pa. Although consistency increased from 12.0 Pa sn at 10,000 g/mol to 26.1 Pa sn for 55,000 g/mol, it then decreased in value from 8.48 Pa sn to 4.92 Pa sn for 360,000 g/mol and 1,300,000 g/mol, respectively. Shear-thinning behavior was reflected by all flow indices, and n decreased in value from 0.320 for 10,000 g/mol until reaching a minimum value of 0.279 at a molecular weight of 55,000 g/mol. Above 55,000 g/mol n increased significantly, and the maximum value was observed in suspensions containing 1,300,000 g/mol. Most notably, compositions including PVP with a molecular weight of 1,300,000 g/mol exhibited the lowest consistency value and the highest flow index of 0.621, which implied that they were the least shear thinning of all PVP-containing suspensions studied. Furthermore, the suspensions with 2.5 vol. % PVP of 55,000 g/mol had the highest consistency and lowest flow index, making it the most shear thinning of the suspensions.

FIG. 10 shows a comparison of the apparent viscosity at different shear rates of all suspensions containing 2.5 vol. % PVP with varying molecular weights examined in this study. Although suspensions with 10,000 g/mol PVP exhibited the lowest apparent viscosity, the overall apparent viscosities for suspensions with PVP of 55,000 g/mol, 360,000 g/mol and 1,300,000 g/mol were comparable, as highlighted in FIG. 10. Due to the order of magnitude increase in molecular weight, suspensions with 1,300,000 g/mol were expected to have a significantly higher viscosity, but they were observed to have only a slightly higher viscosity than suspensions prepared with 55,000 g/mol and 360,000 g/mol over the shear rates evaluated. This slight increase in viscosity could potentially be attributed to the decrease in alumina content in suspensions prepared with PVP of higher molecular weights, but further analysis of suspensions at constant powder loadings would be needed to isolate the main factor.

The low yield point and apparent viscosity made suspensions containing 10,000 g/mol PVP more difficult to control during injection molding, though samples were successfully fabricated for testing. On the other hand, the slightly higher viscosity of suspensions with 1,300,000 g/mol PVP impacted processability by preventing fabrication of alumina samples without large macroscopic defects. These defects likely resulted from air bubbles developing and becoming trapped within suspensions during forming due to the lower degree of pseudoplasticity and the slightly higher apparent viscosity of suspensions with 1,300,000 g/mol PVP. Consequently, parts for mechanical characterization could not be prepared with this high of a molecular weight. Additionally, the specimens exhibited low green and sintered densities when compared with specimens prepared using PVP with lower molecular weights. The inferior microstructural properties that plagued specimens prepared with 1,300,000 g/mol PVP were likely the result of the improper flow characteristics of these suspensions, suggesting that this molecular weight was not suitable for room-temperature processing.

Alumina parts prepared using 10,000 g/mol and 360,000 g/mol PVPs were machinable prior to binder removal. These samples exhibited green densities comparable to those made using 55,000 g/mol PVP, even though the lower molecular weight yielded the highest green densities (refer to Table 2). Green bodies with 10,000 g/mol and 55,000 g/mol had green densities that were statistically similar (p=0.26) and statistically higher than samples with 360,000 g/mol and 1,300,000 g/mol (p<0.05). After binder removal and pressureless sintering, densities of ˜98% TD were attained for specimens prepared with 10,000 g/mol, 55,000 g/mol and 360,000 g/mol (density values highlighted in Table 2). Specimens using 1,300,000 g/mol had a statistically lower density of 3.78 g/cm3 (95% TD).

There appeared to be a notable difference in C-ring strengths of samples with 10,000 g/mol having lower values than those produced with 360,000 g/mol (values shown in Table 2), but statistical analysis revealed that mechanical properties were comparable (all p>0.05). The C-strength values were statistically similar to all samples prepared with varying amounts of 55,000 g/mol PVP. Despite the similar mechanical properties, the highly shear-thinning flow behavior needed for room-temperature processing as well as high green and sintered densities distinguished suspensions containing 2.5 vol. % PVP with a molecular weight of 55,000 g/mol from all other suspensions examined in this study as the optimal PVP molecular weight and concentration to be incorporated into alumina suspensions for room-temperature injection molding.

Those skilled in the art will recognize that nigh-infinite modifications may be made to the specific implementations described above. The implementations should not be limited to the particular limitations described. Other implementations may be possible.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. A method for injection molding, comprising:
a) combining ceramic powder, water, dispersant and water soluble polymer to yield a slurry;
b) injecting the slurry into a mold to yield a shaped slurry pseudobody;
c) drying the shaped slurry psuedobody to yield a green body; and
d) removing the green body from the mold;
wherein steps a), b), c) and d) are performed at room temperature.

2. The method of claim 1 and further comprising:
e) machining the green body to a desired finished shape.

3. The method of claim 1 and further comprising:
f) calcining the green body to remove binder to yield a calcined body; and
g) sintering the calcined body to yield a dense body.

4. The method of claim 1, wherein the slurry contains more than 50 weight percent ceramic powder; and wherein the slurry contains less than 5 weight percent water soluble polymer.

5. The method of claim 4 wherein the ceramic powder is alumina and wherein the water soluble polymer is polyvinylpyrrolidone.

6. The method of claim 5 wherein the alumina powder has an average particle size of about 0.5 mm and wherein the alumina powder has a BET surface area of about 7.8 m²/gm.

7. The method of claim 1 wherein the slurry resists flow as a solid until sufficient shear force is applied to urge the slurry to flow as a liquid.

8. A method for ambient temperature injection molding of ceramic bodies, comprising:
a) combining ceramic powder, water, and dispersant to yield a first admixture;
b) combining water and water soluble polymer to yield a second admixture;
c) combining the first and second admixture to yield a homogeneous slurry;
d) flowing the homogeneous slurry into a mold to yield a molded green body;
e) removing the green body from the mold; and
f) drying the green body;
wherein steps a), b), c), d) and e) are performed at room temperature;
wherein the slurry exhibits yield psuedoplastic flow characteristics;
wherein the slurry contains more than 50 weight percent ceramic powder; and
wherein the slurry contains less than 5 weight percent water soluble polymer.

9. The method of claim 8 wherein the ceramic powder is alumina; wherein the water soluble polymer is polyvinylpyrrolidone; wherein the slurry contains about 2.5 weight percent water soluble polymer; wherein the ceramic powder has an average particle size of about 0.5 mm and wherein the ceramic powder has a BET surface area of about 8 m²/gm.

10. The method of claim 8 and further comprising:
g) machining the green body to a desired finished shape.

11. The method of claim 8 and further comprising:
h) calcining the green body to remove binder to yield a calcined body; and
i) sintering the calcined body to yield a dense body.

12. A room-temperature method of injection molding alumina bodies, comprising:
a) combining alumina powder, water, and dispersant to yield a first admixture;
b) combining water and polyvinylpyrrolidone to yield a second admixture;
c) mixing the first and second admixture to yield a homogeneous yield psuedoplastic slurry;
d) urging the homogeneous yield psuedoplastic slurry into a mold to yield a molded yield psuedoplastic body;
e) removing the molded yield psuedoplastic body from the mold; and
f) drying the molded yield psuedoplastic body to yield a green body;
g) calcining the green body to remove residual polyvinylpyrrolidone to yield a calcined body;
h) firing the calcined body to yield a densified, sintered body
wherein steps a), b), c), d) and e) are performed at room temperature;
wherein the slurry contains more than 40 weight percent aluminapowder; and
wherein the slurry contains between 1 weight percent and 5 weight percent polyvinylpyrrolidone.
